(19) United States
(12) Patent Application Publication
(10) Pub. No.: US 2010/0100377 A1
(43) Pub. Date: Apr. 22, 2010

(54) GENERATING AND PROCESSING FORMS FOR RECEIVING SPEECH DATA

(76) Inventors: Shreedhar Madhavapeddi, Bellevue, WA (US); Mark D. Bertoglio, Seattle, WA (US); Matthew D. Branthwaite, Bellevue, WA (US); John F. Pollard, Seattle, WA (US); Jonathan Wiggs, Olympia, WA (US); Robert Bearman, Sammamish, WA (US)

Correspondence Address: PERKINS COIE LLP;PATENT-SEA, P.O. BOX 1247, SEATTLE, WA, 98111-1247, US

(21) Appl. No.: 12/578,542

(22) Filed: Oct. 13, 2009

Related U.S. Application Data
(60) Provisional application No. 61/195,710, filed on Oct. 10, 2008.

(51) Int. Cl. G10L 15/26; H04W 4/00

(52) U.S. Cl. 704/235; 455/466

(57) ABSTRACT

A system and method for dynamically generating and processing forms for receiving data, such as text-based data or speech data provided over a telephone, mobile device, via a computer and microphone, etc. is disclosed. A form developer can use a toolkit provided by the system to create forms that end-users connect to and complete. The system provides a user-friendly interface for the form developer to create various input fields for the form and impose parameters on the data that may be used to complete or populate those fields. These fields may be included to receive specific information, such as the name of the person filling out the form, or may be free-form, allowing a user to provide a continuous stream of information. Furthermore, the system allows a form developer to establish means for providing access to the form and set access limits on the form. Other aspects are disclosed herein.

### CROSS-REFERENCE TO RELATED APPLICATIONS

This application claims the benefit of assignee's U.S. Provisional Patent Application No. 61/195,710, filed on Oct. 10, 2008, entitled COVERING MULTIPLE SIMULTANEOUS FORMS OF AUDIO INTO TEXT, by Mark D. Bertoglio, Matthew D. Branthwaite, Shreedhar Madhavapeddi, John F. Pollard, and Jonathan Wiggs, which is herein incorporated by reference in its entirety.

### BACKGROUND

More and more companies are relying on feedback from their employees, customers, suppliers, shareholders, vendors, etc. to assess their relationships with these entities and the success of campaigns to improve these relationships. These companies rely on various surveying techniques to collect this information, such as distributing and collecting paper forms or contacting the entities via email or web-based forms. However, paper forms are often difficult to collect and process and are often overlooked or thrown away upon receipt. Similarly, prospective surveyees often ignore the survey emails, if they have not already been filtered as spam. Some companies rely on interactive voice response (IVR) systems for collecting survey information. These systems typically call users, or allow users to call in, and present a series of questions that the user may answer via voice and keypad input. However, users are typically limited to short responses, such as “Yes” or “No” or a single number (e.g., rating between 1 and 5).

Furthermore, languages and utilities for generating IVR surveys are often difficult or cumbersome to use and require some level of expertise to successfully create and test a survey. For example, Voice XML can be a difficult language for a user to create simple IVR surveys. Moreover, Voice XML utilities are often just as difficult to use and do not provide a simple mechanism for testing the execution of a Voice XML project.

The need exists for a method and system that overcomes these problems and progresses the state of the art, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a block diagram illustrating an environment in which the system operates in some examples.

FIG. 2 is a flow diagram illustrating the processing of a component of the system in some examples.

FIG. 3 is a display diagram illustrating an interface for customizing an access means and fields for a form in some examples.

FIG. 4 is a display diagram illustrating an interface for editing field parameters in some examples.

FIG. 5 is a flow diagram illustrating the processing of an execute form component in some examples.

FIG. 6 is a flow diagram illustrating the processing of an authorize component in some examples.

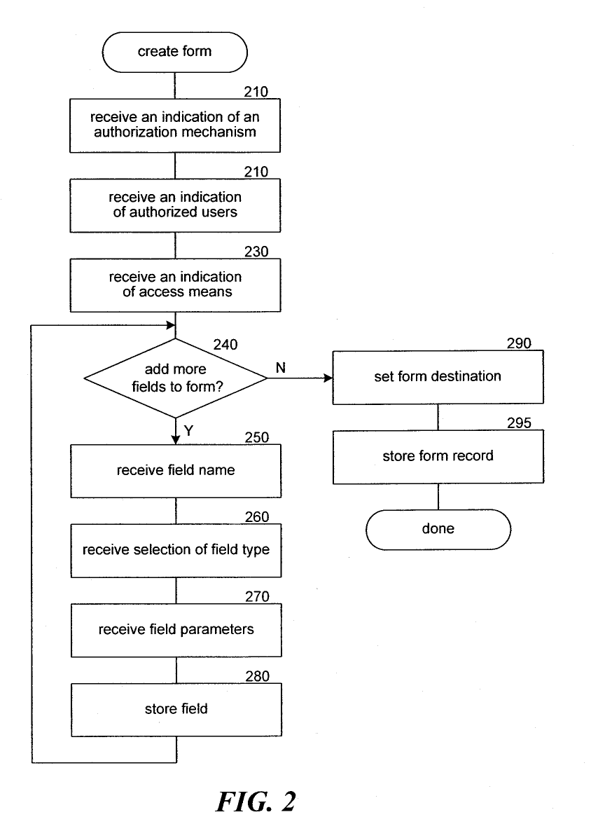

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 240 is first introduced and discussed with respect to FIG. 2).

### DETAILED DESCRIPTION

A system and method for dynamically generating and processing forms for receiving data, such as text-based data or speech data provided over a telephone, mobile device, via a computer and microphone, etc. is disclosed. A form developer can use a software toolkit provided by the system to create forms that end-users connect to and complete via any number of data entry methods, such as live or recorded audio, Dual-Tone Multi-frequency (DTMF) signals (i.e., Touch-Tone tones) combined with a multi-tap or predictive text methods, plain text (e.g., e-mail or Short Message Service (SMS) messages), and so on. The system allows a form developer with any level of expertise to create and deploy voice applications while writing little to no code. The system provides a user-friendly interface for the form developer to create various input fields for the form and impose parameters on the data that may be used to complete or populate those fields, such as data type and input method, and establish processes for handling received data. These fields may be included to receive specific information, such as the name of the person filling out the form, or may be free-form, allowing a user to provide a continuous stream of information. Furthermore, the system allows a form developer to establish means for providing access to the form, such as a telephone number or uniform resource locator (URL). The form developer may also set access limits on the form, such as which users may access the form, how and when those users may access the form, and a technique for authorizing or authenticating those users. The user information may be provided and stored in any number of ways, such as a collection of comma separated values, user profiles, etc. In some examples, the system may offer a development “sandbox” or simulation system to allow form developers to quickly and easily test their forms. While generally described herein as implemented via a telephone call to a telephone number, various communications options are possible, including voice over IP (VoIP) calls, communications via short messaging (e.g. SMS, MMS, etc.), communications via email, communications via URLs (e.g., HTML-based forms), etc.

In some examples, a form developer may create a form by defining a set of fields associated with that form. For example, a manager of a sales team may establish a form that her sales team uses to memorialize sales meetings. The form may consist of a “Client Name” field corresponding to the name of the client that the salesperson completing the form met with, a “Date” field corresponding to the date of the meeting, and a “Comments” field corresponding to free-form speech data provided by the salesperson pertaining to the meeting. For example, a salesperson may use the “Comments” field to provide information about who the salesperson met with, the outcome of the meeting, and any action items the salesperson is to complete as a result of the meeting. Each field may have an associated type, such as integer, string, audio, video, image, etc.

In some examples, the system may include a number of template forms containing fields that a form developer can use as-is or as a basis or starting point for developing his or her own custom form. For example, the system may include a “Customer Feedback” form template that includes fields that companies are likely to use when soliciting customer feedback, such as fields for entering the customer's name, the location of the relevant store, the name of any employees the customer worked with, and a free-form speech field for providing general feedback. The form developer may add, remove, or modify any or all of the fields to best fit his or her needs.

The system can be applied generally to a variety of areas and settings in addition to the sales team example described above. For example, the system may also be used in legal, travel and hospitality, insurance, financial services, retail, non-profit, health care environments, etc. In some examples, the system may provide a predefined template or templates for each of these settings to provide form developers with a starting point for creating forms, which can be editable to add, delete, or modify default fields.

In some examples, the form developer can set parameters for each of a form's fields, such as a limit on the number of characters or length of speech that may be used to complete a field, acceptable methods for entering data, whether or not the data is to be confirmed upon input, or a list of accepted values for completing the field. For example, in the sales team example described above, the “Client Name” field may be limited to 30 characters and may require that a user enter the client's name using a non-verbal input means (e.g., by using the keypad of a touch-tone phone) to prevent a salesperson from disclosing the identity of clients in public. As another example, the “Date” field may require that the salesperson confirm the entered date. The system may allow the user to confirm the data by repeating the interpreted data back to the user and asking the user to, for example, press the “1” key or ask that the user repeat or re-enter the data. As another example, the “Comments” field may be limited to receiving 60-180 seconds of audio. A speech-to-text component of the system may be configured to recognize speech and convert the speech to text.

In some examples, a user accesses the form by dialing a telephone number associated with the form. The form may be a public form (i.e., a form that anybody may access) or a private form (i.e., a form that only authorized users may access). The system can confirm that the user is authorized to access the form in any number of ways. For example, the system may verify the caller's voice using a voice recognition mechanism or that the call is originating from an authorized telephone number using caller ID data. As another example, the system may require that the user enter a security code associated with the user (e.g., personal identification number (PIN)) or a security code associated with the form. Alternatively, the system may use some combination of voice recognition, caller ID data, and security code(s) during the authentication process. Once the user is authorized, the system executes the form by prompting the user to enter data for each of the associated fields. For example, the system may prompt the user by saying, “For which client are you submitting a client meeting form?” The user would then have the opportunity to key in (assuming that speech entry is not available) the name of the client. The system may then confirm or store the received data and proceed to the next field. The system progresses through each field in the form prompting the user to enter data and then receiving data from the user until the form is complete or the user is disconnected. The system may follow a predefined order for presenting each field to the user or may allow the user to determine the order. The system may present the form to the user via any of a number of presentation formats, such as via a web browser or other application on a computing device, via SMS or Multimedia Messaging Service (MMS) messages on a mobile device, via an exchange of emails, or any combination thereof.

In some examples, a single device may allow a user to enter data into a form via multiple input techniques. For example, the system may distribute a form to a mobile phone and allow a user to enter data into a field by speaking into a microphone of the mobile device or using a keypad of the mobile device to enter text. The form may be pushed to and locally stored on the phone. The user can then access the form and have it displayed on the phone. The user may then have the option of either typing in and manually entering data for fields of the form, or by simply selecting a field (e.g. tapping on that displayed field if the phone has a touch-sensitive screen) and then speaking into the phone's microphone so that the system described herein converts the uttered data into alphanumeric data.

In some examples, the system may perform additional processing on the received form data after the user has entered form data. For example, the system may tabulate results for a number of form fields or forms submitted by different users, convert the received data into, for example, a graphical form such as a chart, send the received or processed data to interested parties, such as the salesperson completing the form and the sales team manager in the scenario described above, and so on.

Various examples of the system will now be described. The following description provides specific details for a thorough understanding and enabling description of these examples. One skilled in the relevant art will understand, however, that the system may be practiced without many of these details. Likewise, one skilled in the relevant art will also understand that the system can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the system. Indeed, certain terms may even be emphasized below; however, any terminology intended to be interpreted in any restricted manner will be overtly and specifically defined as such in this Detailed Description section.

### System Description

The following discussion provides a brief, general description of a representative environment in which the system can be implemented. Although not required, aspects of the system may be described below in the general context of computer-executable instructions, such as routines executed by a general-purpose data processing device (e.g., a server computer, a personal computer, or mobile/portable device). Those skilled in the relevant art will appreciate that the system can be practiced with other communications, data processing, or computer system configurations, including: wireless devices, Internet appliances, hand-held devices (including personal digital assistants (PDAs)), wearable computers, all manner of cellular or mobile telephones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

Aspects of the system can be embodied in a special purpose computer or data processor that is specifically programmed, configured, or constructed to perform one or more of the computer-executable instructions explained in detail herein. Aspects of the system can also be practiced in distributed computing environments where tasks or modules are performed by remote processing devices, which are linked through a communications network, such as a Local Area Network (LAN), Wide Area Network (WAN), Storage Area Network (SAN), Fibre Channel, or the Internet. In a distributed computing environment, program modules may be located in both local and remote memory storage devices.

Aspects of the system may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the system may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

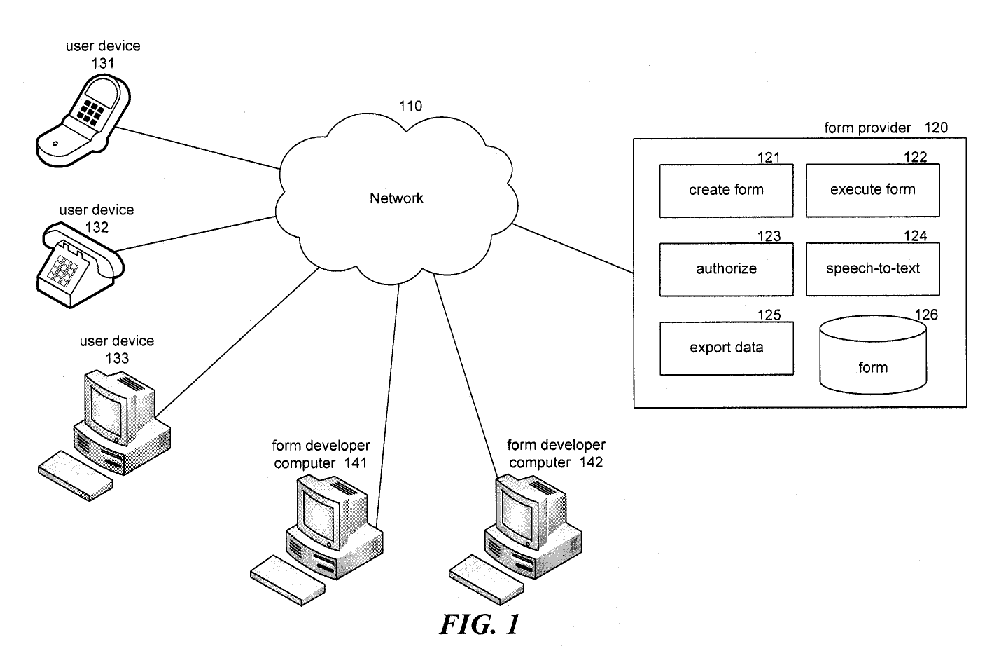

FIG. 1 is a block diagram illustrating an environment in which the system operates in some examples. In this example, the system resides at form provider computer 120, which is accessible by user devices 131, 132, and 133 and form developer computers 141 and 141 via network 110. The system is comprised of create form component 121, execute form component 122, authorize component 123, speech-to-text component 124, export data component 125, and form store 126. Create form component 121, which can be invoked by a form developer, provides an interface for the form developer to create and edit form attributes, form fields, form behavior, etc. Execute form component 122 is invoked to retrieve data from a user by prompting the user to enter data and receiving data from the user in response. Authorize component 123 is invoked to authorize a user's access to a particular form. Speech-to-text component 124 is invoked to convert speech data to text. Export data component 125 is invoked to perform additional processing on received form data, such as distributing form data, converting form data, or initiating additional business processes based on form data. Form store 126 stores information about a number of forms, such as the fields and the parameters for those fields, access parameters for the forms, and data collection in response to execution of the forms. One skilled in the art will understand form store 126 may store form information in any number of formats, such as a flat file, a relational database, an online analytical processing (OLAP) hypercube, etc. End-users may connect to the system via user devices 131, 132, and 133. For example, a user may dial-in to the system via mobile device 131 or telephone 132 or may connect via a web browser or other user interface at user device 133. Form developers may connect to the system via form developer computers 141 or 142 to create or edit forms and receive data related to user-provided form data.

FIG. 2 is a flow diagram illustrating the processing of a create form component in some examples. The component may be invoked by a form developer to create or edit a form. The form developer may first login to the system or provide some sort of authentication credentials (e.g., username and password) prior to creating a form. In step 210, the component receives an indication of an authorization mechanism for authorizing access to the form, such as who can access the form, when they may access the form, and how they can access the form. For example, the authorization mechanism may rely on current information about the device being used to complete the form, such as a caller ID value, a network address, a current geographic location (e.g., global positioning satellite information obtained from a mobile telephone), etc. The authorization mechanism may also require a security code for access. The security code can be used to verify that the user has been invited to access the form, such as via an email to access the form including a security code associated with the form, or to verify the identity of the user, such as a PIN unique to the user or a security code associated with a group of users. In some cases, the form may require a combination of a security code unique to the form and a security code unique to the user to access the form. The authorization mechanism may also require voice recognition or other biometric security measure. One skilled in the art will recognize that any combination of the above-described mechanisms may be used authorize access to a form.

In step 220, the component receives an indication of users authorized to access the form. For example, the component may receive a list of users and information about those users that the system can use to authorize a given user during the authorization process, such as the user's telephone number(s), which can be compared to received caller ID values, security codes associated with the user, the user's email addresses, voice recognition data that the system can use to compare to speech data received during the authorization process, etc. Furthermore, users may have an associated time period during which they can access the form. For example, one group of users may have 24-hour access to the form while others may only access the form between 8 AM and 5 PM Monday through Friday. Alternatively, a time period for accessing the form may be applied to all of the users. The list may specify access rights to users individually, or in groups, and the system may maintain information about which users belong to which groups.

In some examples, the form may not be accessible via incoming connections. Instead, the system may be used to periodically contact users to enter data via the form. For example, a company may use the system to automatically survey customers for feedback on their recent interactions with the company. As another example, a sales manager may create a form that automatically contacts the members of her sales team for quarterly sales numbers. The system can then batch process this information and export data. For example, the system may analyze and generate statistical information about the received numbers and distribute this information to the sales manager along with a laudatory SMS message to the top salesperson of the group.

In step 230, the component receives an indication of access means for connecting to the form. For example, the component may receive a telephone number or telephone numbers associated with the form. The telephone numbers may be provided, for example, by a telephone number allocation service, such as Junction Networks' OnSIP service. The form may have a number of associated telephone numbers that can be used to differentiate between users, such as users calling from different regions or users with different privileges. Moreover, some users may only be able to access the form via certain telephone numbers. As another example, the component may receive an email address or a website address for accessing the form.

In steps 240-280, the component loops through each field to be added to the form and configures that field. In step 240, if there are additional fields to add to the form, the component continues at step 250, else the component continues at step 290. In step 250, the component receives a name for the field. The name can be used to identify the field and may be descriptive of the data the form developer expects to receive via the field, such as “Client Name,” “Date,” “Comments,” etc.

In step 260, the component receives a selection of a type for the new field. The type corresponds to the type of data the form developer expects or desires to receive for a particular field. For example, the type may be audio data, text, numbers (e.g., integers or floating point values), a selection of a value from a predefined list, etc.

In step 270, the component receives parameters for the field. The parameters correspond to behavior of the field and for processing data entered into that field. For example, the parameters may include acceptable means for entering data into the field, such as text-only, voice-only, voice or text, etc. The parameters may include a prompt, such as a plaintext message to send or display to the user or a recorded message that can be played for the user. The parameters may also include an indication of whether data entered into a particular field should be confirmed prior to moving on to another field. If the data is to be confirmed, the parameters may also include at least one confidence score for qualifying received data as acceptable input to the field. When the system converts speech, or data entered via a keypad, to text, the process may include a confidence score corresponding to the probability that the conversion was correct. If converted data for a particular field has a confidence score that is below the confidence score for that field, the user may be asked to confirm or re-enter the data. Each field may also have a “show advertisement” option which, when selected, will cause the system to attempt to correlate an advertisement with user input to the field and present the advertisement to the user. In some cases, the “show advertisement” option may also have an associated confidence score threshold. If the received input to the field cannot be recognized with a confidence score that exceeds the associated confidence score threshold, the system may forgo the presentation of an advertisement to the user. The system may incorporation an advertising described in related U.S. Provisional Patent Application No. 60/822,910, filed on Aug. 18, 2006, entitled CONTEXTUAL VOICE BASED ADVERTISING SYSTEM AND METHOD, which is herein incorporated by reference in its entirety.

The parameters may also include an indication of which field to proceed to based on received data. For example, execution of the form may branch to one set of questions if the user responds negatively to a question pertaining to the user's satisfaction with a particular service and with branch to another set of questions if the user responds positively. The parameters may also include an enumerated list of acceptable values for the field or a range of values. For example, a field for entering the name of a month may have an associated list containing 12 entries, one for each month. Of course, this list could be expanded if the form developer expected to receive data in more than one language or format. Some fields may be “auto-populate” fields intended to be populated by the system, rather than a user, when the form executed. For example, a caller ID field may be automatically populated using caller ID information received when a user connects to the form via a telephone. As another example, the system may automatically populate fields for the date and time at which the form is executed.

In step 280, the component stores the collected information for the field and then loops back to step 240 to determine whether there are additional fields to add to the form.

In step 290, the component sets a destination for distributing the data received as a result of executing the form. For example, the system may send the received form data to the form developer or a form administrator via an email, text message, voicemail, etc. or may store the data in a form store, database, spreadsheet or other storage means and in any format. Furthermore, the received data may be sent to additional processes of the system for analyzing, converting, or manipulating the data prior to, or in addition to, distribution or storage, such as tabulating or correlating data collected for a particular form, generating tables or charts to represent the data, etc. Additionally, the system may submit the data to third-party processes, such as a cloud computing services, (e.g., those provided by SALESFORCE.com), social or professional networking sites, etc. Furthermore, the system may incorporate communication systems, such as those described in related to U.S. Provisional Patent Application No. 60/859,052, filed on Nov. 14, 2006, entitled CATEGORIZATION AND CORRESPONDING ACTIONS ON VOICE MESSAGES, SYSTEMS AND METHOD, which is herein incorporated by reference in its entirety, related to U.S. Provisional Patent Application No. 60/859,049, filed on Nov. 14, 2006, entitled VOICE DRIVEN PRESENCE FOR IM NETWORKS AND MULTIMODAL COMMUNICATIONS ACROSS MESSAGING NETWORKS, which is herein incorporated by reference in its entirety, related to U.S. patent application Ser. No. 11/840,174, filed Aug. 16, 2007, entitled PROVIDING CONTEXTUAL INFORMATION FOR SPOKEN INFORMATION, which is herein incorporated by reference in its entirety, or related to U.S. patent application Ser. No. 11/940,229, filed Nov. 14, 2007, entitled PERFORMING ACTIONS FOR USERS BASED ON SPOKEN INFORMATION, which is herein incorporated by reference in its entirety.

In step 295, the component stores the collected form data as a form record, which may include collecting general information about the form, such as a title, default language, etc. Processing of the component then completes.

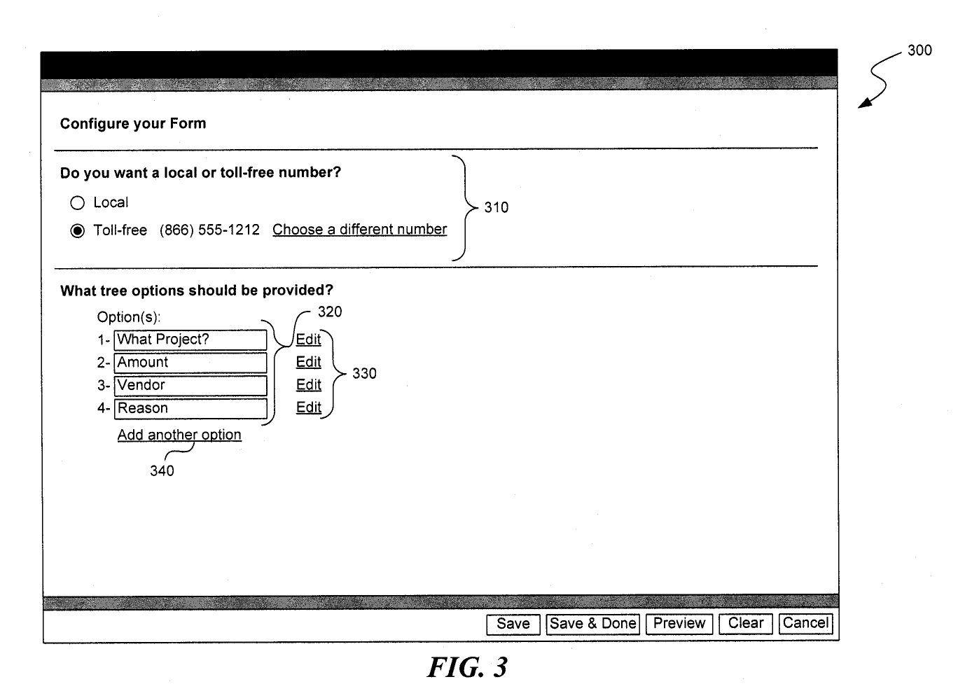

FIG. 3 is a display diagram illustrating an interface for customizing an access means and fields for a form in some examples. In this example, display page 300 includes a menu 310 for selecting a telephone number for accessing the form. Menu 310 includes two options, Local and Toll-Free, which can be selected via a radio button. Upon selecting one of the radio buttons, an appropriate number is selected and allocated to the form. In some examples, the system may have a number of reserved telephone numbers to allocate to the form. In other examples, the system may request a telephone number from a telephone number allocation service. Display page 300 also includes field labels 320, each displaying the name of a field of the form. A form developer can edit any of the fields by clicking an “Edit” link 330 associated with the field. The form developer may select the “Add another option” link 340 to add a new field to the form.

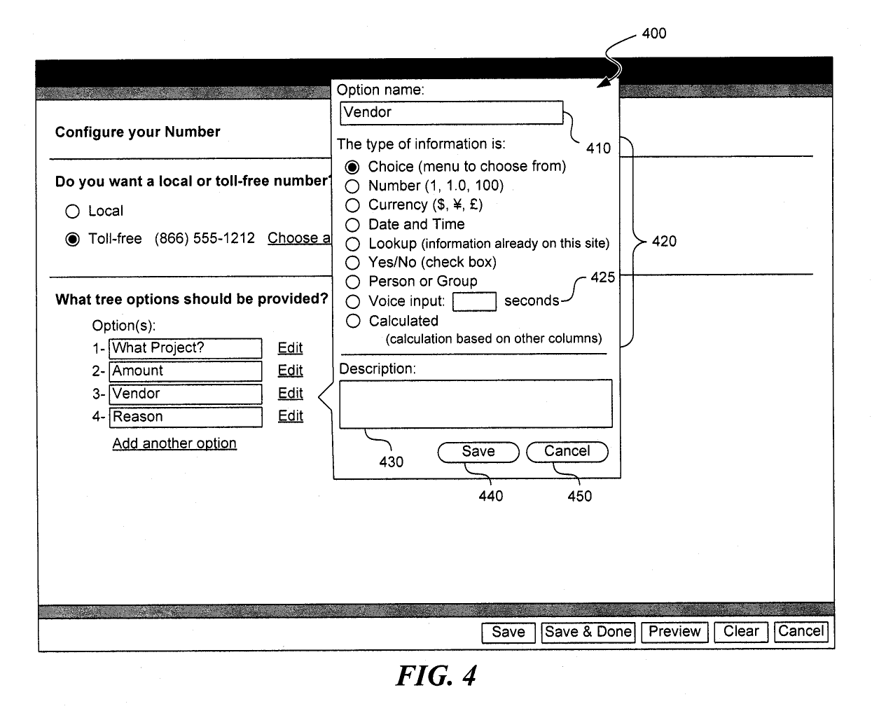

FIG. 4 is a display diagram illustrating an interface for editing field parameters in some examples. In this example, the system has displayed edit menu 400 in response to a form developer selecting an “Edit” link associated with a “Vendor” field. Option name label 410 includes the name of the currently selected field. If edit menu 400 were displayed in response to a form developer clicking “Add another option link,” option name label 410 may be blank, or populated with a default value. Edit menu 400 also includes a menu 420 for selecting a data type to assign to the currently selected field. Menu 420 provides a non-exclusive list of data types that a form developer may assign to a field, which can be selected using the associated radio buttons. Each of the options may have an associated secondary menu that the system displays to the form developer upon selection of the associated radio button or, alternatively, “Save” button 440. For example, when a form developer selects the “Choice” option radio button, the system may present a form for inputting the relevant menu options. Voice input menu item 425 allows a user to specify a limit (i.e., the maximum number of seconds) for recorded voice input for the selected field. Description box 430 provides a location for a user to enter detailed descriptive information for the currently selected field, such as when or why the field was added to the form. Once the form developer is done configuring the currently selected field, the form developer may click “Save” button 440 to save any changes or “Cancel” button 450 to ignore any changes.

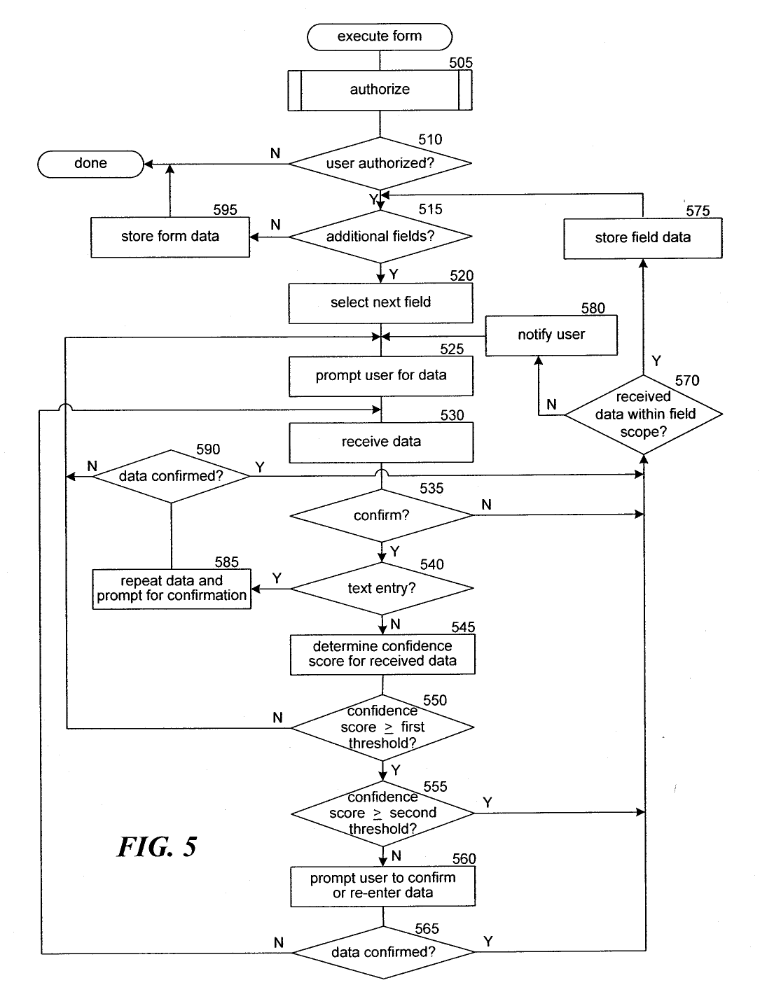

FIG. 5 is a flow diagram illustrating the processing of an execute form component in some examples. The component is executed, for example, when a user connects to a form, such as by dialing an associated telephone number of accessing an associated URL. In step 505, the component invokes an authorize component to authorize the user accessing the form. In step 510, if the user is authorized to access the form, the component continues at step 515, else processing of the component completes.

In step 515, if additional fields remain for which the user has not entered or been prompted to enter data, the component continues at step 520, else the component continues at step 595 where the component stores the collected form data and any other data associated with the form, such as metadata (e.g., the date and time when the form was executed or the user who completed the form) or supplemental data generated by processing the collected form data. For example, the system may add the information collected or generated during execution of the form to a form store. The component may also send a confirmatory email or text message to the user who completed the form, form administrator, etc. Processing of the component then completes.

In step 520, the component selects the next field for which the user has not entered or been prompted to enter data. In some cases, the progression of fields may be static while in others the progression may dynamically adapt based on user responses.

In step 525, the component prompts the user to enter data for the currently selected field. For example, the component may play a recorded message to the user over the telephone, such as “What is your name?” As another example, the component may send an email or an SMS message to the user or display an input box on a web page.

In step 530, the component receives data from the user. For example, the component may receive speech data spoken by the user or text data sent via email, an SMS message, or submitted through a web-based form. If the received data is speech data, the component may also invoke a speech-to-text component to convert the speech data to text. The speech-to-text component may output a confidence score for the converted speech data. The speech-to-text component may incorporate, for example, a standard dictionary, contextual information, or field metadata into the analysis of the speech data to assist in the conversion. For example, the system may generate a personalized grammar using the user's contact list and associated links and use the personalized grammar when converting the user's speech to text. As another example, if the field is a “Month” field, the speech-to-text component may assign a higher score to words that correspond to months.

In step 535, if the current field is configured to require confirmation, then the component continues at step 540, else the component continues at step 570. In step 540, if the received data was entered as text data, then the component continues at step 585, else the component continues at step 545 to confirm speech data. In step 585, the component repeats the interpreted data to the user and prompts the user for confirmation. For example, the component may ask, “Did you say Joe? If so, say ‘Yes’ or press 1. Otherwise say ‘No’ or press 2.” In step 590, if the data is confirmed (e.g., if the user says, “Yes”), then the component continues at step 570, else the component loops back to step 525 where the user is again prompted to enter data for the selected field.

In steps 545-565, the component attempts to confirm converted speech data using two confidence score thresholds. The first threshold is used to eliminate converted speech data whose conversion has a low likelihood of being correct. For example, if the converted speech data has a confidence score below the first threshold (e.g., 20%), the component discards the data and prompts the user to re-enter the data. The second threshold, which is greater than the first threshold, is used to identify converted speech with a high likelihood of being correct. For example, if the converted speech data has a confidence score greater than or equal to the second threshold (e.g., 90%), the component automatically accepts the data without user confirmation. If, however, the confidence score for the converted speech does not satisfy the first two tests, the component prompts the user to confirm the data or re-enter the data by, for example, saying “If you said Smith, please say ‘Yes’ or press 1. Otherwise, please repeat your previous response.”

In step 545, the component determines a confidence score for the received data by, for example, analyzing the output of a speech-to-text component used to convert the received speech data to text. In step 550, if the confidence score is greater than or equal to a first threshold associated with the field, the component continues at step 555, else the component loops back to step 525 where the user is again prompted to enter data for the selected field. In step 555, if the confidence score is greater than or equal to a second threshold associated with the field, the component continues at step 570, else the component continues at step 560. In step 560, the component prompts the user to confirm or re-enter the data. In step 565, if the user confirms the data, then the component continues at step 570, else the component loops back to step 530 to receive data from the user for the selected field. In some examples, a field may also have an associated retry limit. When the user has attempted to provide data for a field a number of times equal to the retry limit, the user may be prompted to enter data via another mechanism, such as using a keypad, sending an SMS message, or speaking to a live operator. Alternatively, the component may skip to the next field without collecting data for the selected field. If the system cannot recognize the speech data automatically, it may be directed to a human transcriber based on, for example, language, technical details of the contents of the speech data, the transcriber's familiarity with the form and the provided data, etc.

In step 570, if the received data is within a predefined scope for the field, then the component continues at step 575, else the component continues at step 580. In step 580, the component notifies the user that the received data is not with the field's scope and then loops back to step 525 where the user is again prompted to enter data for the selected field. For example, if the field has a predefined range of acceptable values of 1-10 and the user enters 15, then the component will notify the user that the entered data, 15, is outside of the acceptable range, 1-10. As another example, if the field has an enumerated list of acceptable values corresponding to months and the user provides data that does not correspond to a month, the user will be notified and prompted to re-enter the data.

In step 575, the component stores the received field data and then loops back to step 515 to determine whether additional fields remain for which the user has not entered or been prompted to enter data. In some examples, the component may perform additional processing on the data in addition to storing the data. For example, the component may analyze the data for particular keywords that may be used to index the data for search purposes. As another example, the keywords may be used to trigger additional business processes. For example, if the user indicates that he needs to make a lunch reservation for his next meeting with a particular client who happens to be in Denver, the system may identify the keyword “reservation” and automatically identify a possible location, in this case “Denver.” The system may then send the user an advertisement to one or more restaurants in Denver or a list containing restaurants the user might prefer. The component may use a predetermined dictionary to identify keywords or may automatically identify keywords by performing natural language processing techniques on the data.

In some examples, the system may provide statistics about the success or usability of each field, such as the number of times that a user had to re-enter data for a field, either due to unconfirmed data or data that did not conform to a field's scope, or the average confidence score of received data for a field. The form developer can use this information to identify fields that may need to be modified, such as fields with a prompt that users do not understand or fields pertaining to data users do not want to provide.

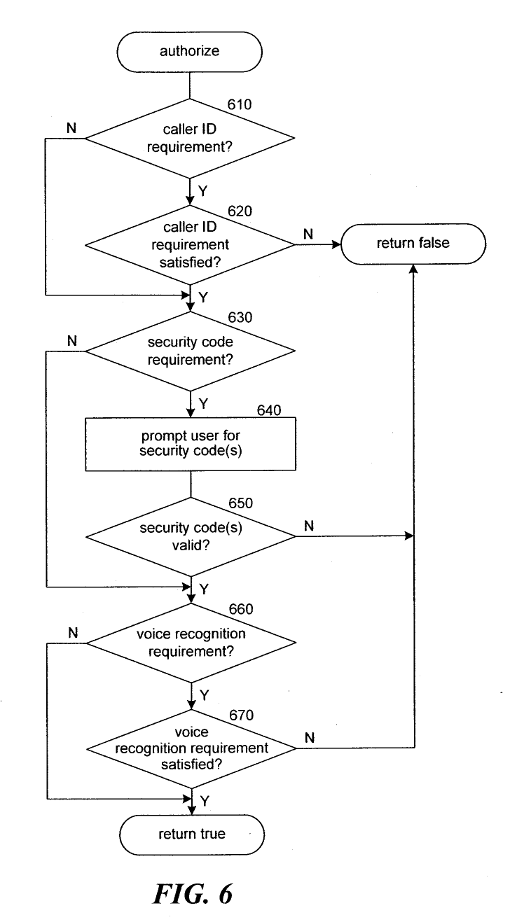

FIG. 6 is a flow diagram illustrating the processing of an authorize component in some examples. The authorize component is invoked to authorize a user attempting to access a form and is based on authorization parameters associated with the form. In step 610, if the form has a caller ID requirement, then the component continues at step 620, else the component continues at step 630.

In step 620, if the caller ID requirement is satisfied, then the component continues at step 630, else the component returns “false,” indicating that the authorization has failed. For example, a form developer may create a form that may only be accessed by a limited number of telephones, such as the cellular telephones of a sales team. As another example, a form developer may create a form that can only be accessed by telephones from a distinct set of area codes (e.g., 206, 425, 253) to provide some geographical limitations on users who may access the form. When a user attempts to access a form using a telephone that does not meet the caller ID requirements, the user will be denied access to the form.

In step 630, if the form has a security code requirement, then the component continues at step 640, else the component continues at step 660. In step 640, the component prompts the user for a security code. For example, the component may ask the user to enter their personal security code or a security code associated with the form. In step 650, if the provided security code(s) are valid, then the component continues at step 660, else the component returns “false.”

In step 660, if the form has a voice recognition component, then the component continues at step 670, else the component returns “true,” indicating that the authorization process has succeeded. In step 670, if the user satisfies the voice recognition requirement, then the component returns “true,” else the component returns “false.” For example, the component may prompt the user to say their name and compare the received data to a prerecorded voice file. Additional authorization requirements may be included, such as timing requirements, prior completion of associated forms, correct response to a predetermined question (e.g. user's favorite color), and so on.

### Conclusion

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while one aspect of the invention may be recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

I/We claim:

1. A method for executing a voice-based form, the method comprising:
receiving from a user a request to connect to a voice-based form, the voice-based form having a plurality of fields, each field having an associated type;
determining whether the user is authorized to access the voice-based form based at least on identification information received from the user;
after the user is authorized to access the voice-based form, for at least one of the plurality of fields,
prompting the user to provide data for the field,
receiving data from the user for the field,
when it is determined that the data received from the user for the field is voice data,
converting the voice data to text data,
generating a confidence score for the converted voice data, and
when it is determined that the generated confidence score does not exceed a first threshold, prompting the user re-enter the data, and
storing data received from the user for the field; and
providing the stored data for each of the plurality of fields to a predetermined destination location, wherein the destination location is accessible via a network.

2. The method of claim 1 wherein the request to connect to the voice-based form is a telephone call to a phone number associated with the voice-based form, and wherein determining whether the user is authorized to access the voice-based form includes determining whether a telephone number of caller identification (caller ID) data associated with the telephone call is an authorized telephone number.

3. The method of claim 1 wherein the request to connect to the voice-based form is a call to a number associated with the voice-based form.

4. The method of claim 1 wherein the request to connect to the voice-based form is a short message received from a mobile device of the user, wherein prompting the user to provide data for at least one of the plurality of fields includes sending a short message to the mobile device of the user, and wherein data received from the user for at least one of the fields is received via a Multimedia Messaging Service (MMS) message.

5. The method of claim 1 wherein the request to connect to the voice-based form is a Short Message Service (SMS) message received from a mobile device of the user and wherein prompting the user to provide data for at least one of the plurality of fields includes sending an SMS message to the mobile device of the user.

6. The method of claim 1, further comprising sending to a form administrator an indication of the stored data for each of the plurality of fields, and wherein the indication of the stored data for each of the plurality of fields is sent to the form administrator via an email message.

7. A system for generating and processing voice-based forms, the system comprising:
a form creation component configured to provide an interface for a form developer to define multiple fields for a voice-based form,
wherein each field of the form has an associated type and,
wherein each of the multiple fields has multiple parameters for prompting a user to enter data for each of the multiple fields and for processing data provided by the user,
wherein at least one of the multiple fields is associated with a free-form audio type;
a form access component configured to establish a connection with the user to receive input data for the form;
a form execution component configured to prompt the user to provide data for each of the multiple fields of the form, and to receive data from the user for each of the multiple fields of the form; and
a speech-to-text component configured to convert audio data received from a user into text data for the form.

8. The system of claim 7 wherein the form access component is configured to establish a connection with the user at least in part by automatically and periodically placing a telephone call to the user.

9. The system of claim 7 wherein the form access component is configured to establish a connection with the user at least in part by sending an email to the user.

10. The system of claim 7 wherein the speech-to-text component is configured to generate a confidence score for converted audio data, the confidence score corresponding to a probability that the speech-to-text component correctly converted the audio data to text data.

11. The system of claim 7 wherein the speech-to-text component is configured to identify keywords within audio data.

12. The system of claim 11, further comprising:
a advertisement component configured to present advertisements to the user based on identified keywords.

13. A computer-readable storage medium storing instructions that, when executed by a computer, cause the computer to perform a method of generating a form for gathering user input, the method comprising:
providing at least two different authorization options for users who are authorized to provide user input to the form;
receiving user input selecting one of the two authorization options;
providing at least two data input fields for the form;
receiving user input defining the at least two data input fields, including at least one parameter defining data acceptable for the two data input fields;
providing at least one free-speech input field for the form, wherein the free-speech input field may receive spoken audio input, and wherein the received spoken audio input is to be automatically converted from speech to text for the free-speech input field;
setting a destination for data input to the form; and,
creating the form based on the received user input selecting one of the two authorization options and defining the at least two data input fields.

14. The computer-readable storage medium of claim 13 wherein the two different authorization options include a public option that permits anyone to provide input, and a private option that permits only a select set of users to provide input based on phone numbers for the select set of users;
wherein parameters for the two different data fields include at least two of: number, currency, date and time, yes/no, and a name of a person or group; and,
wherein the destination includes an email address or text message number for sending data received via the form, a database or spreadsheet to be updated or revised based on data received via the form, or an external application to process data received via the form.

15. The computer-readable storage medium of claim 13 wherein the form is an extensible markup language (XML) form, and wherein providing the at least two input fields includes providing application programming interfaces (APIs) that define acceptable input for the two input fields, wherein the acceptable input includes two different data types, and wherein the APIs define feedback to users for data received via the two input fields.

16. The computer-readable storage medium of claim 13, further comprising providing at least two different template forms, wherein the template forms are associated with two different workflows and include different data input fields, and wherein the method further comprises:
receiving user input selecting one of the template forms; and,
receiving user input modifying the selected template form to either add an additional data input field, or modify one of the different data input fields.

17. The computer-readable storage medium of claim 13 wherein one of the two different authorization options includes verifying a user's voice from a stored version of the user's voice.

18. The computer-readable storage medium of claim 13, further comprising receiving user input defining certain times when, or certain geographic locations from where, user input is acceptable.

19. The computer-readable storage medium of claim 13, further comprising:
receiving user input for when to periodically send the created form to multiple users to gather data;
automatically forwarding the form to the multiple users;
automatically gathering data from the multiple users via the form;
tabulating the gathered data; and,
producing a graphical representation of the tabulated data.

20. The computer-readable storage medium of claim 13, further comprising providing an option of whether to show an advertisement based on received user input, wherein the advertisement is not provided if a confidence of received data is below a threshold.

21. The computer-readable storage medium of claim 13, further comprising automatically sending a confirming message to a user after creating the form.

22. The computer-readable storage medium of claim 13, further comprising automatically adding additional data fields, wherein the automatically added data fields include a phone number of a user providing input to the created form, a URL of a user providing input to the created form, a time when a user provided input to the created form, or a name of a user providing input to the created form.

23. The computer-readable storage medium of claim 13 wherein providing the at least two input fields includes providing application programming interfaces (APIs) that define acceptable input data for the two input fields, wherein the input data is received as spoken input, and
when a confidence of a conversion of the spoken input is below a lower threshold, user feedback or instructions are provided to request that the user again provide the spoken input;
when a confidence of a conversion of the spoken input is above the lower threshold but below an upper threshold, user feedback or instructions are provided to request that the user confirm the spoken input; and,
when a confidence of a conversion of the spoken input above the upper threshold, no user feedback or instructions are provided.

24. The computer-readable storage medium of claim 13, further comprising:
automatically gathering statistics from data input to the at least two data input fields by multiple users of the form; and,
automatically providing usability data or notification that data input to at least one of the two data input fields frequently is below a confidence level.

25. A method performed by a mobile device, such a wireless telecommunications device, for providing input to a previously created form, wherein the mobile device includes at least a manual input portion and an audio input portion, wherein the mobile device is at least intermittently coupled with a network, and wherein the network is coupled to a computer, the method comprising:
receiving the created form from the computer and via the network, wherein the form includes:
at least one data input field having a predetermined format, and
at least one free-text field configured to receive uttered audio input, and
wherein the received uttered audio input is to be automatically converted to text for the free-text field;
presenting the form to the user, including individually presenting the one data input field and the one free-text field;
receiving, from the user, data for input to the one data input field;
receiving, from the user, uttered audio input for input to the free-text field; and,
providing to the network the received data for the one data input field and the received uttered audio input, wherein the received uttered audio input is to be automatically converted to text for the free-text field.

26. The method of claim 25 wherein presenting the form to the user includes displaying the form to the user, and wherein receiving data for input to the one data input field includes receiving manual user input selecting the one data input field, and receiving spoken user input for the selected one data input field.

27. The method of claim 25 wherein the mobile device is a wireless mobile phone, and wherein the received form is stored on the mobile phone for later data input by the user.

28. A system for generating forms, wherein the forms may receive audio input, the system comprising:
means for providing authorization regarding which users can provide input to a form;
means for providing at least two data input fields for the form;
means for providing at least one free-speech input field, wherein the free-speech input field may receive spoken audio input, and wherein the received spoken audio input is to be automatically converted from speech to text for the free-speech input field; and,
means for defining an output destination for user data received via the form.
